(19) United States
(12) Patent Application Publication
(10) Pub. No.: US 2014/0193782 A1
(43) Pub. Date: Jul. 10, 2014

(54) COLOR EDUCATION SYSTEM FOR THE VISUALLY IMPAIRED

(71) Applicant: UMM AL-QURA UNIVERSITY, Makkah (SA)

(72) Inventor: MERFAT SIRAJ OMAR SHIRBINI, MAKKAH (SA)

(73) Assignee: UMM AL-QURA UNIVERSITY, MAKKAH (SA)

(21) Appl. No.: 13/736,027

(22) Filed: Jan. 7, 2013

(51) Int. Cl. G09B 21/00

(52) U.S. Cl. CPC G09B 21/007
USPC 434/98

(57) ABSTRACT

The color education system for the visually impaired is a battery-powered device including a console having a plurality of color identification modules mounted on the top platform, each of the rectangular members being formed of a unique color and having a corresponding touchpad sensor mounted thereon. The touchpad sensor has a Braille inscription mounted thereon spelling the color of the rectangular member in Braille. The touchpad sensors are connected to a processor that identifies which touchpad has been touched by a user. A voice synthesizer connected to the processor is programmed to announce the color associated with the touchpad touched by the user. A speaker or headset is connected to the audio output of the voice synthesizer, thus allowing the user to hear the announced color. Each rectangular member also has a well defined therein, and a vial containing a pigment dye of the corresponding color disposed in the well.

### BACKGROUND OF THE INVENTION

1. Field of the Invention

The present invention relates to educational aids for the visually impaired, and particularly to a color education system for the visually impaired.

2. Description of the Related Art

Visually impaired (VI) people “read” or “write” using tactile communication means. The most famous means is the Braille system, which was devised in 1821 by Louis Braille, a blind Frenchman. Each Braille character or cell is made up of six dot positions, arranged in a rectangle containing two columns of three dots each. A dot may be raised at any of the six positions to form sixty-four permutations, including the arrangement in which no dots are raised. For reference purposes, a particular permutation may be described by naming the positions where dots are raised, the positions being universally numbered 1 to 3 from top to bottom on the left, and 4 to 6 from top to bottom on the right. For example, dots 1-3-4 would describe a cell with three dots raised, at the top and bottom in the left column and on top of the right column. In Braille text, dots 1-3-4 represent the letter m. The lines of horizontal Braille text are separated by a space, much like visible printed text, so that the dots of one line can be differentiated from the Braille text above and below. Punctuation is represented by its own unique set of characters. The presence or absence of dots gives the coding for the symbol. In such a manner, symbols representing colors may be encoded in Braille text. Yet there is no Braille-capable device currently available to allow a visually impaired person to tell the color of a pigmented dye, for example.

Thus, a color education system for the visually impaired solving the aforementioned problems is desired.

### SUMMARY OF THE INVENTION

The color education system for the visually impaired utilizes the senses of touch and hearing to assist in the learning process. A battery-powered portable console includes eight sets of Braille characters, each set being disposed on a corresponding panel that identifies a corresponding one of each of the main eight colors. An electrical system within the console housing is designed to power speakers that announce the name of the color associated with each panel as it is pressed. Thus, the visually impaired person gains knowledge of the color by the sense of hearing, concomitant with the sense of touching.

These and other features of the present invention will become readily apparent upon further review of the following specification and drawings.

### BRIEF DESCRIPTION OF THE DRAWINGS

FIG. 1 is a perspective view of a color education system for the visually impaired according to the present invention, the vials of pigment being omitted.

FIG. 2 is a rear perspective view of the color education system for the visually impaired according to the present invention.

FIG. 3 is a front perspective view of the color education system for the visually impaired according to the present invention.

FIG. 4 is a block diagram of an electronic circuit of the color education system for the visually impaired according to the present invention.

Similar reference characters denote corresponding features consistently throughout the attached drawings.

### DETAILED DESCRIPTION OF THE PREFERRED EMBODIMENTS

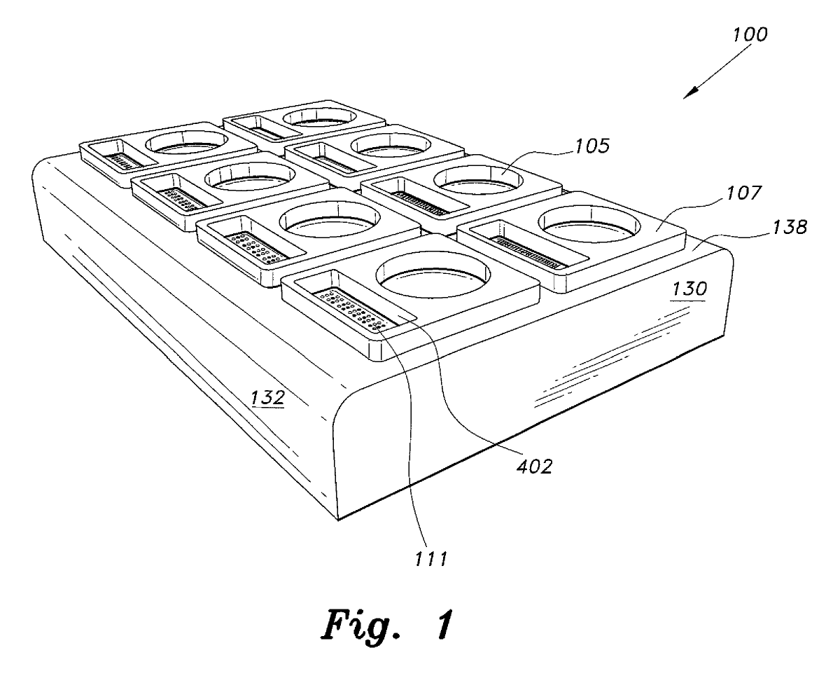

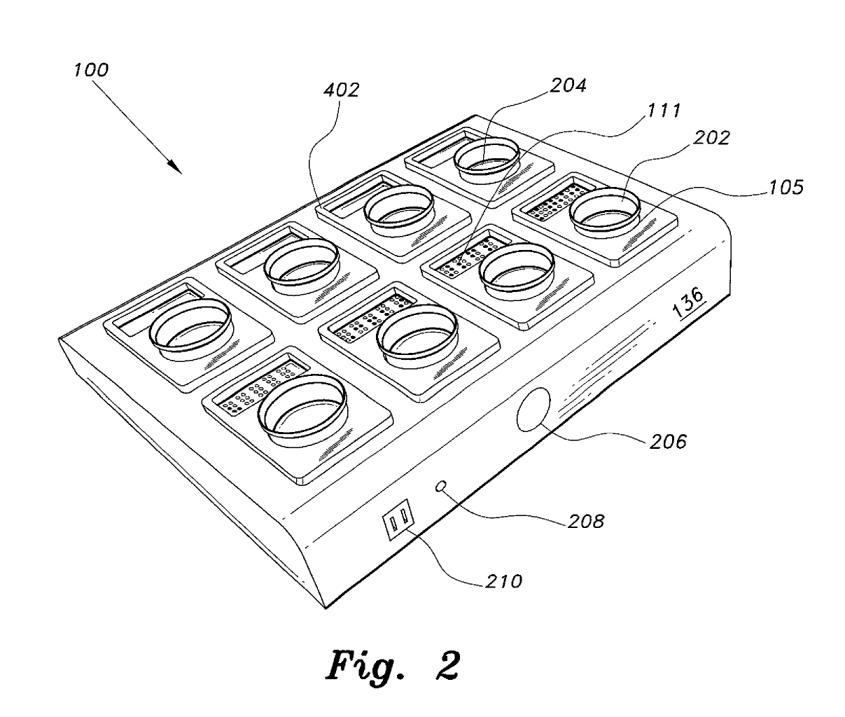

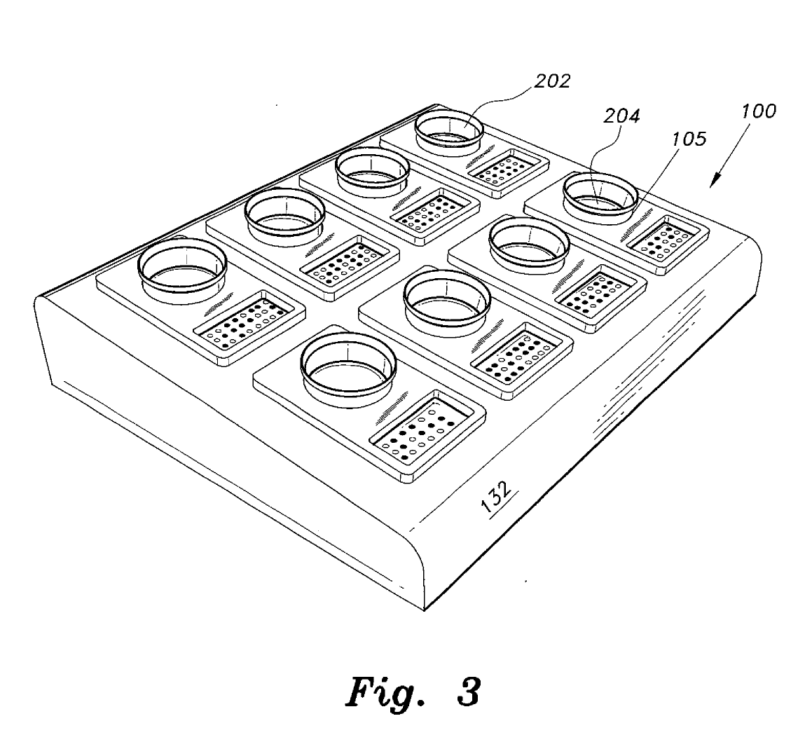

As shown in FIGS. 1-3, the color education system for the visually impaired includes a housing or console 100 used to contain pigments 204 exhibiting the colors white, black, red, blue, green, orange, purple, and yellow. The console 100 has wells that receive eight vials 202 of pigments having the aforementioned pigments. The console 100 has two side panels 130, a front panel 132 a rear panel 136 and a platform 138. The side panels 130 may be tapered so that front portion of the console 100 is of a lower height than the rear portion of the console 100. Mounted on the platform 138 of the console 100 are eight touchpad sensor panels 402 having Braille inscriptions 111 representing the corresponding colors of the dye pigments 204 carried in recessed wells 105 holding vials 202 of the associated pigmented dyes 204. The recessed wells 105 are formed in rectangular members 107 that exhibit the corresponding color, and which include the touchpad sensor panels 402 mounted thereon.

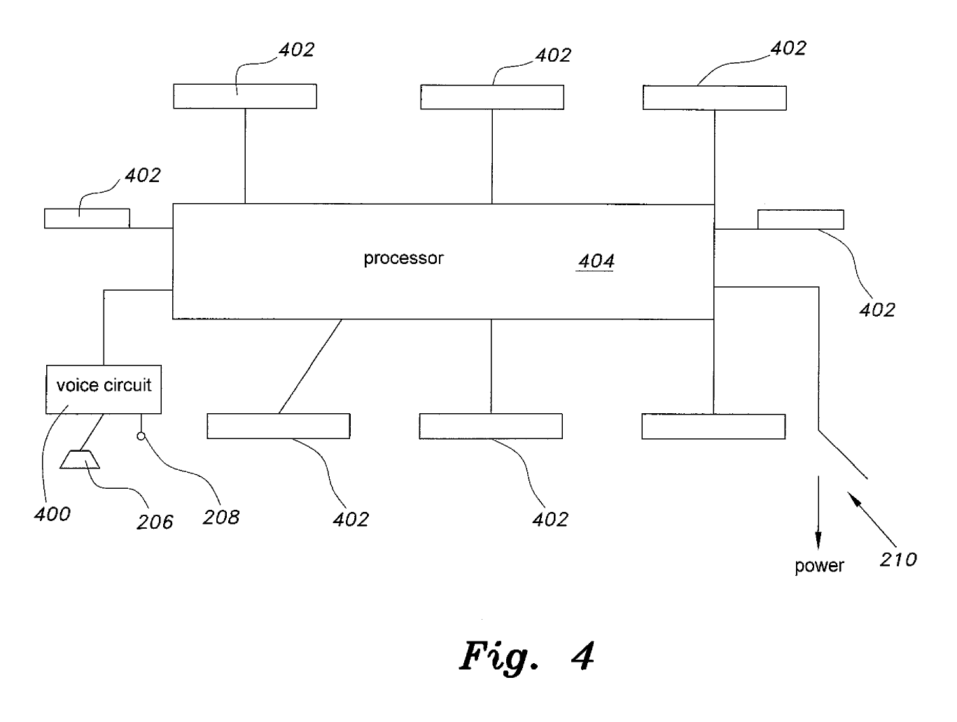

As shown in FIG. 4, the touchpad sensors 402 are connected to a processor 404 that identifies which of the touchpads 402 has been touched by a user. A voice synthesizer 400 connected to the processor 404 is programmed to announce the color associated with the touchpad 402 touched by the user. It will be understood that the diagrams in the Figures depicting the color education system 100 for the visually impaired are exemplary only, and may be embodied in a dedicated electronic device having a microprocessor, microcontroller, digital signal processor, application specific integrated circuit, field programmable gate array, any combination of the aforementioned devices, or other device that combines the functionality of the color education system for the visually impaired onto a single chip or multiple chips programmed to carry out the system functionality described herein, and include software stored on a computer readable media that can be loaded into main memory and executed by the processing unit to carry out the functionality of the apparatus and processing steps of the method described herein.

A speaker 206 and headset jack 208 are mounted on the rear panel 136 and are connected to the audio output of the voice synthesizer 400, thus allowing the user to hear the announced color and vial 202 associated with the touched touchpad 402. This procedure, via touch and hearing, reinforces learning of the color by the visually impaired user. The device is generally configured to identify each of the main eight colors. A power switch 210 mounted on the rear panel 136 switches battery power to the unit. The user reads the Braille inscription 111, which spells out the color of the corresponding rectangular panel, and presses the corresponding touch pad 402, causing the speech synthesizer to announce the color verbally on the speaker 206 or to a headset plugged into the jack 208.

It is to be understood that the present invention is not limited to the embodiments described above, but encompasses any and all embodiments within the scope of the following claims.

I claim:

1. A color education system for the visually impaired, comprising:
a console housing having two side panels, a top platform, a front panel and a rear panel;
a plurality of color identification modules disposed on the top platform, each of the modules having:
a rectangular member formed of a color unique to the rectangular member;
a touchpad sensor mounted on the rectangular member;
a Braille inscription disposed on the touchpad sensor, the Braille inscription spelling out the unique color in Braille;
a well formed in the rectangular member; and
a vial of a pigmented dye having the color of the rectangular member disposed in the well;
a digital processing circuit disposed inside the console housing, the touchpad sensors being operably connected to the digital processing circuit for identifying a specific one of the is touchpad sensors when the touchpad sensor is touched; and
a voice synthesizer connected to the digital processing circuit, the voice synthesizer being configured to announce the color of the rectangular member when the touchpad mounted on the rectangular member is touched.

2. The color education system according to claim 1, further comprising a power switch connected to the digital processing circuit to enable/disable color announcing by said voice synthesizer.

3. The color education system according to claim 2, wherein said side panels are tapered in height, thereby making a front portion of said console housing lower in height than a rear portion of said console housing.

4. The color education system for the visually impaired according to claim 3, wherein said plurality of color identification modules consists of eight modules corresponding to the colors white, black, red, blue, green, orange, purple, and yellow.
